(19) United States
(12) Patent Application Publication
(10) Pub. No.: US 2018/0239060 A1
(43) Pub. Date: Aug. 23, 2018

(54) ANTIREFLECTION FILM AND FUNCTIONAL GLASS

(71) Applicant: FUJIFILM CORPORATION, Tokyo (JP)

(72) Inventors: Hidemasa HOSODA, Shizuoka (JP); Naoki KOITO, Shizuoka (JP); Ryou MATSUNO, Shizuoka (JP); Hideki YASUDA, Shizuoka (JP)

(21) Appl. No.: 15/956,768

(22) Filed: Apr. 19, 2018

Related U.S. Application Data
(63) Continuation of application No. PCT/JP2016/004648, filed on Oct. 21, 2016.

(30) Foreign Application Priority Data
Oct. 21, 2015 (JP) 2015-207506

(51) Int. Cl. G02B 1/111; G02B 1/14; C09D 5/00; G02B 1/18; G02B 1/12

(52) U.S. Cl. CPC G02B 1/111; G02B 1/14; G02B 1/12; G02B 1/18; C09D 5/006

(57) ABSTRACT

Provided are an antireflection film having high durability and a functional glass including the antireflection film.

An antireflection film includes a transparent substrate (10), an antireflection layer (30) provided on one surface side of the transparent substrate (10), and a hard coat layer (20) included between the transparent substrate (10) and the antireflection layer (30), in which the antireflection layer (30) is formed by laminating, from the hard coat layer (20) side, a layer of high refractive index (32) having a refractive index higher than a refractive index of the hard coat layer (20), a silver nano-disk layer (36) formed by dispersing a plurality of silver nano-disks (35) in a binder (33), and a layer of low refractive index (38) having a refractive index lower than the refractive index of the layer of high refractive index (32) in this order.

### CROSS-REFERENCE TO RELATED APPLICATION

This application is a Continuation of International Application No. PCT/JP2016/004648, filed Oct. 21, 2016, which claims priority to Japanese Patent Application No. 2015-207506 filed Oct. 21, 2015. Each of the above applications is hereby expressly incorporated by reference, in its entirety, into the present application.

### BACKGROUND OF THE INVENTION

### 1. Field of the Invention

The present invention relates to an antireflection film having an antireflection function with respect to an incidence ray and a functional glass to which the antireflection film is applied.

### 2. Description of the Related Art

In the related art, in order to prevent decrease in visibility due to reflection of an external light source or scenery, an antireflection film including an antireflection film on a transparent substrate has been applied on the glass surface of a display. A dielectric multilayer or a configuration including a visible light wavelength absorption layer formed of a metal fine particle layer in a multilayer is known as such an antireflection film for visible light.

In JP2015-129909A, as the antireflection film, an antireflection film including, on a transparent substrate, a laminate of a metal-fine particle-containing layer that contains metal flat plate particles, in particular, silver nano-disks, and a dielectric layer has been proposed. According to this antireflection film, it is possible to obtain an effect of preventing reflection in a broad spectrum.

Meanwhile, JP2001-310423A discloses an antireflection film including an antireflection functional layer on a transparent support through a hard coat layer.

In JP2001-310423A, the hard coat layer is disposed in order to improve scratch resistance of the transparent support, and a method of providing a scratch resistant support in which deformation is decreased by improving the mechanical performance of the hard coat layer is proposed.

### SUMMARY OF THE INVENTION

The antireflection film including the laminate of the metal-fine particle-containing layer that contains silver nano-disks and a dielectric layer described in JP2015-129909A is a technique that achieves significantly low reflectivity with a small number of lamination.

On the other hand, the present inventors performed abrasion resistance evaluation when water was interposed, which assumed wiping with water, in the case where the antireflection film described in JP2015-129909A was used as a film for a window, and as a result, it was found that there was a problem of occurrence of peeling. In addition, as a result of performing a light-fast test, which was assumed to be performed outdoors, it was found that there were cases where a phenomenon in which the antireflection film became cloudy, and transparency thereof decreased occurred, in a case where the film was exposed to the solar light for a long period of time. The problem of the film becoming cloudy was found to specifically arise only in the case where the antireflection layer included the metal-fine particle-containing layer.

The present invention has been made in view of the above circumstances, and an object of the present invention is to provide an antireflection film having high antireflection properties and high durability which allows the film to withstand long term usage outdoors. Another object of the present invention is to provide a functional glass including the antireflection film having high durability.

An antireflection film of the present invention comprises: a transparent substrate; an antireflection layer provided on one surface side of the transparent substrate; and a hard coat layer provided between the transparent substrate and the antireflection layer, in which the antireflection layer is formed by laminating, from the hard coat layer side, a layer of high refractive index having a refractive index higher than a refractive index of the hard coat layer, a silver nano-disk layer formed by dispersing a plurality of silver nano-disks in a binder, and a layer of low refractive index having a refractive index lower than the refractive index of the layer of high refractive index in this order.

Here, the hard coat layer is a layer having hardness of greater than or equal to HB in a pencil hardness test (formerly known as JIS K5400 pencil scratch test). By providing the hard coat layer, it is possible to prevent scratch and peeling from occurring during a coating process and due to packaging, transportation, bonding, or cleaning in the form of the antireflection film of the present application.

The “silver nano-disk” is a particle which has a flat plate shape that has two facing main planes, the main plane having an equivalent circle diameter of several nanometers to several hundreds of nanometers, and refers to a particle of which an aspect ratio is greater than or equal to 3, the aspect ratio being a ratio of an equivalent circle diameter to a thickness, which is a distance between the main planes.

“The silver nano-disks being dispersed” indicates that greater than or equal to 80% of the silver nano-disks are arranged separately from each other. “Being arranged separately from each other” indicates a state in which there is an interval between the closest fine particles of greater than or equal to 1 nm. It is more preferable that the interval between the closest fine particles of the fine particles arranged separately from each other is greater than or equal to 10 nm.

It is preferable that the antireflection film of the present invention is the antireflection film in which the hard coat layer is formed of a cured product of an aqueous resin composition.

Here, it is preferable that an aqueous resin is a polyurethane or an acrylic resin.

It is preferable that a film thickness of the hard coat layer is from 1 μm to 10 μm.

It is preferable that the transparent substrate is a polyester film.

It is preferable that an area ratio of the silver nano-disks in the silver nano-disk layer in plan view is from 10% to 40%.

It is preferable that the layer of low refractive index is formed by dispersing hollow silica in the binder.

A functional glass of the present invention comprises: a glass plate; and the antireflection film of the present invention described above adhering to at least one surface of the glass plate.

The antireflection film of the present invention has favorable antireflection properties which allow a region where reflectivity is significantly low to cover a wide wavelength range, by including the silver nano-disk layer in the antireflection layer. In addition, since the antireflection film of the present invention includes the hard coat layer between the transparent substrate and the antireflection layer, the antireflection film is a film of which the weakness caused by the inclusion of the silver nano-disk layer is covered and which has high resistance to rubbing and impact. Furthermore, by including the hard coat layer, generation of cloudiness can be suppressed even in a case where the film is exposed to the solar light for a long period of time, and high durability can be realized.

### BRIEF DESCRIPTION OF THE DRAWINGS

FIG. 1 is a schematic cross-sectional view illustrating a configuration of an antireflection film of an embodiment of the present invention.

FIG. 2 is a scanning electron microscope (SEM) image of a silver nano-disk layer in plan view.

FIG. 3 is a schematic view illustrating an example of a silver nano-disk.

FIG. 4 is a schematic view illustrating another example of the silver nano-disk.

FIG. 5 is a graph illustrating a simulation of wavelength dependency of transmittance at each aspect ratio of the silver nano-disk.

FIG. 6 is a schematic cross-sectional view illustrating a presence state of the silver nano-disk layer including the silver nano-disks in the antireflection film of the present invention, and illustrating an angle (0) between the silver nano-disk layer including the silver nano-disks (parallel to a plane of a substrate) and a main plane of the silver nano-disk (a surface determining an equivalent circle diameter D).

FIG. 7 is a schematic cross-sectional view illustrating a presence state of the silver nano-disk layer including the silver nano-disks, and illustrating a presence region of the silver nano-disks in a depth direction of the antireflection structure of the silver nano-disk layer.

FIG. 8 is a schematic cross-sectional view illustrating another example of the presence state of the silver nano-disk layer including the silver nano-disks.

FIG. 9 is a schematic view illustrating an embodiment of a functional glass of the present invention.

### DESCRIPTION OF THE PREFERRED EMBODIMENTS

Hereinafter, embodiments of the present invention will be described.

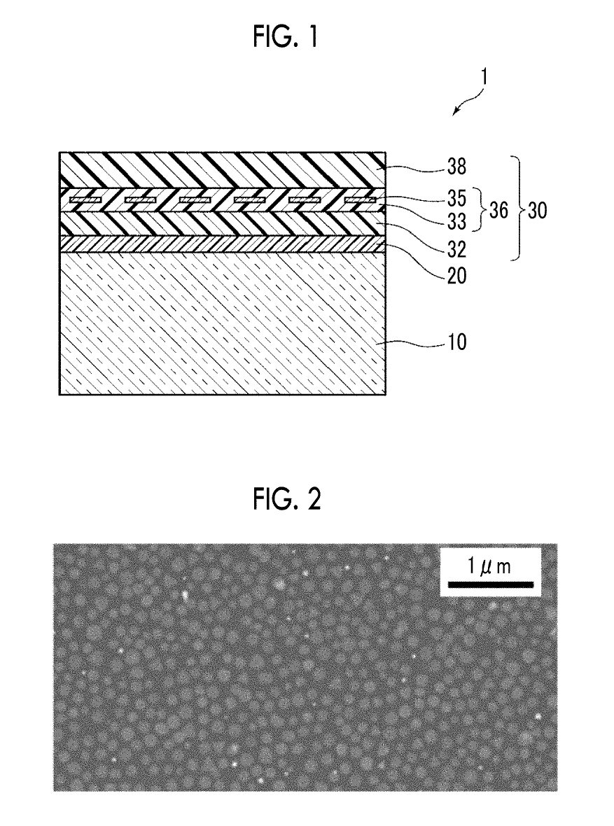

FIG. 1 is a schematic cross-sectional view illustrating a schematic configuration of an antireflection film 1 according to an embodiment of the present invention. As shown in FIG. 1, the antireflection film 1 of this embodiment includes a transparent substrate 10, an antireflection layer 30 provided on one surface side of the transparent substrate 10, and a hard coat layer 20 provided between the transparent substrate 10 and the antireflection layer 30. The antireflection layer 30 is formed by laminating, from the hard coat layer 20 side, a layer of high refractive index 32 having a refractive index higher than a refractive index of the hard coat layer 20, a silver nano-disk layer 36 formed by dispersing a plurality of silver nano-disks 35 in a binder 33, and a layer of low refractive index 38 having a refractive index lower than the refractive index of the transparent substrate 10 in this order.

As described above, the hard coat layer 20 is a layer having hardness of greater than or equal to HB in a pencil hardness test, and by sandwiching the hard coat layer 20 between the transparent substrate 10 and the antireflection layer 30, it is possible to prevent scratch and peeling from occurring due to packaging, transportation, bonding, or cleaning.

It is preferable that the hard coat layer 20 is configured with a material that does not have absorption in the visible light range, from the viewpoint of transparency. The hard coat layer 20 may include a particle consisting of a metal oxide. It is preferable that the particle that is added has a refractive index that is close to the resin described below that configures the layer and has a particle diameter of less than or equal to 200 nm, from the viewpoint of preventing inside haze. As a raw material of the hard coat layer, an auxiliary for compatibilization such as an auxiliary for film formation is used in combination, or selection of materials having good compatibility with each other is suitably used.

The refractive index of the hard coat layer 20 is preferably from 1.5 to 1.6. Here, the refractive index refers to a numerical value at a wavelength of 550 nm. Hereinafter, unless otherwise particularly specified, the refractive indices refer to refractive indices at a wavelength of 550 nm.

The material of the hard coat layer 20 is not particularly limited insofar as the layer satisfies the above conditions. The kind of the material and the formation method can also be suitably selected according to the purpose, and examples of the kind of the material include a thermosetting or photocurable resin such as an acrylic resin, a silicone-based resin, a melamine-based resin, a urethane-based resin, an alkyd-based resin, and a fluorine-based resin. Among these, a urethane-based resin is preferable, and, from the viewpoint of forming a bond with the upper layer, a material having a reactive group such as a silanol group in the side chain is more preferable. A thickness of the hard coat layer is not particularly limited and can be suitably selected according to the purpose. From the viewpoint of improving scratch resistance when water is interposed, the thickness is preferably more than or equal to 1 μm, and from the viewpoint of coating properties and stiffness of a coating layer-containing film, the thickness is preferably less than or equal to 50 μm and is more preferably less than or equal to 10 μm.

It is particularly preferable that the hard coat layer 20 is a cured product of an aqueous resin composition.

Here, the aqueous resin composition refers to a composition having a property of solidifying upon removing an aqueous solvent that is contained in the composition. In general, examples of the kind of the aqueous resin composition include a forcibly emulsified resin obtained by forcibly emulsifying a resin which does not have emulsifying properties and water-solubility using a surfactant or the like, a self-emulsifying resin which is obtained by emulsifying and dispersing a resin having self-emulsifying properties, a water-soluble resin obtained by dissolving a resin having water-solubility, and the like. The forcibly emulsified resin and the self-emulsifying resin are in a dispersed state in which the resin has a particle diameter at the composition level. The water-soluble resin is in a dissolved state in which the resin does not have a particle diameter at the composition level.

The fact that the hard coat layer is formed of the cured product of the aqueous resin composition can be confirmed by observing a transmission electron microscope image (TEM image) of the hard coat layer or by composition analysis. Specifically, in a dispersion of the forcibly emulsified resin, the self-emulsifying resin, and the like, a grain boundary is observed on a dried film surface in the TEM image. In a case of the water-soluble resin, the resin has many hydrophilic groups on a terminal group or a side chain, and thus, the resin can be determined by analysis. The cured product of the aqueous resin composition can be distinguished from an ultraviolet ray curable resin compound or a thermosetting resin compound that requires a polymerization initiator in that the cured product of the aqueous resin composition does not contain a polymerization initiator.

The aqueous solvent is a dispersion medium of which a main component is water, and a content of water contained in the solvent is preferably 70% to 100% and is more preferably 80% to 100%. As a solvent other than water, a solvent that is soluble in water, for example, alcohols such as methanol, ethanol, and isopropyl alcohol, ketones such as acetone and methylethyl ketone, glycol ethers such as N-methylpyrrolidone (NMP), tetrahydrofuran, and butyl cellosolve, and the like, is preferably used. In addition, in order to improve dispersion stability of a polymer in the aqueous resin composition, coating properties, and coating film properties after drying, the aqueous solvent may include a surfactant, ammonia, and amines such as triethylamine and N,N-dimethylethanolamine at several percent with respect to the dispersion.

Specific examples of a resin in the aqueous resin composition include polyester, polyolefin, an acrylic resin, polyurethane, and the like. From the viewpoint of favorable hardness and transparency of the coated film that is formed, it is preferable that the aqueous resin composition contains at least one resin selected from the group consisting of polyurethane and an acrylic resin.

(Acrylic Resin)

The acrylic resin used as the resin in the aqueous resin composition is a resin including a monomer having at least one group selected from an acryloyl group and a methacryloyl group as a polymerization component, and, in a case where the total mass of the acrylic resin is set as 100 mass %, a resin in which the total mass of a repeating unit formed by polymerization exceeds 50 mass % is preferable. Here, the monomer having at least one group selected from an acryloyl group and a methacryloyl group will be hereinafter referred to as a “(meth)acrylic monomer” as appropriate.

The acrylic resin is obtained by homopolymerization of a (meth)acrylic monomer or by copolymerization of the (meth)acrylic monomer with another monomer.

In a case where the acrylic resin is a copolymer of the (meth)acrylic monomer and another monomer, another monomer that is subjected to copolymerization with the (meth)acrylic monomer may be any monomer having a carbon-carbon double bond and may be any monomer having an ester bond or a urethane bond.

The copolymer of the (meth)acrylic monomer and another monomer may be any one of a random copolymer, a block copolymer, and a graft copolymer.

Here, a mixture containing another polymer, such as a polyester resin and a urethane resin, which is a polymer obtained by homopolymerizing the (meth)acrylic monomer or copolymerizing the (meth)acrylic monomer with another monomer in a solution or a dispersion liquid of a polymer other than the acrylic resin, such as a polymer obtained by homopolymerizing the (meth)acrylic monomer or copolymerizing the (meth)acrylic monomer with another monomer in a polyester solution or a polyester dispersion liquid, a polymer obtained by homopolymerizing the (meth)acrylic monomer or copolymerizing the (meth)acrylic monomer with another monomer in a polyurethane solution or a polyurethane dispersion liquid, and the like, is included in the acrylic resin.

In order to further improve adhesiveness to a layer that adjoins the hard coat layer, the acrylic resin may also have at least one group selected from a hydroxy group and an amino group.

Specific examples of the (meth)acrylic monomer that can be used in the synthesis of the acrylic resin is not particularly limited. Representative examples of the (meth)acrylic monomer include (meth)acrylic acid; hydroxyalkyl (meth)acrylate such as 2-hydroxyethyl (meth)acrylate, 2-hydroxypropyl (meth)acrylate, and 4-hydroxybutyl (meth)acrylate; alkyl (meth)acrylate such as methyl (meth)acrylate, ethyl (meth)acrylate, propyl (meth)acrylate, butyl (meth)acrylate, and lauryl (meth)acrylate; (meth)acrylamide; N-substituted acryl amide such as diacetone acrylamide and N-methylol acrylamide; (meth)acrylonitrile; a silicon-containing (meth)acrylic monomer such as γ-methacryloxypropyltrimethoxysilane, and the like.

In addition, a commercially available acrylic resin may also be used. Examples of a commercially available product of the acrylic resin that can be used in the hard coat layer include JURYMER (registered trademark) ET-410 (manufactured by TOAGOSEI CO., LTD.), AS-563A (trade name: manufactured by DAICEL FINECHEM LTD.), BONRON (registered trademark) XPS-002 (manufactured by Mitsui Chemicals, Inc.), and the like.

(Polyurethane Resin)

A polyurethane resin is a collective term for a polymer having a urethane bond in the main chain, and the polyurethane resin is generally a product of a reaction between diisocyanate and polyol.

Examples of the diisocyanate used in the synthesis of the polyurethane resin include toluene diisocyanate (TDI), diphenylmethane diisocyanate (MDI), naphthalene diisocyanate (NDI), tolidine diisocyanate (TODI), hexamethylene diisocyanate (HDI), isophorone diisocyanate (IPDI), and the like.

Examples of the polyol used in the synthesis of the polyurethane resin include ethylene glycol, propylene glycol, glycerin, hexanetriol, and the like.

As the polyurethane resin used as the resin in the aqueous resin composition, a polyurethane resin of which, by performing a chain elongation treatment, the molecular weight has been increased compared to the polyurethane resin obtained by the reaction between diisocyanate and polyol can be used, in addition to a general polyurethane resin.

The diisocyanate, the polyol, and the chain elongation treatment described in relation to the polyurethane resin are described in detail, for example, in “Polyurethane Handbook” (edited by Iwata Keiji, NIKKAN KOGYO SHIMBUN, LTD., published in 1987), and description in “Polyurethane Handbook” regarding the polyurethane resin and raw materials thereof can be applied in the present invention according to the purpose.

A commercially available polyurethane resin may also be used. Examples of the commercially available product include SUPERFLEX (registered trademark) 470, 210, 150HS, and 150HF and ELASTRON (registered trademark) H-3 (all manufactured by DKS Co. Ltd.), HYDRAN (registered trademark) AP-20, AP-40F, and WLS-210 (all manufactured by DIC Corporation), TAKELAC (registered trademark) W-6061, WS-5100, WS-4000, and WSA-5920 and OLESTER (registered trademark) UD-350 (all manufactured by Mitsui Chemicals, Inc.), and the like. Among these, from the viewpoint of having a silanol group, WS-5100 and WS-4000 are particularly preferable.

Furthermore, an ultraviolet absorbent may be added to the hard coat layer 20. The ultraviolet absorbent is not particularly limited, however, it is preferable to use a compound having a triazine ring independently or a mixture obtained by mixing a plurality of ultraviolet absorbents. By including the ultraviolet absorbent in the hard coat layer 20, it is possible to suppress yellowing of the transparent substrate in a case where the antireflection film is exposed to the solar light for a long period of time.

The hard coat layer 20 is preferably formed by coating the transparent substrate with a coating liquid containing the aqueous resin composition and drying the coating liquid. At this time, a thickness of the coated film is preferably adjusted such that a dried film thickness is from 1 μm to 10 μm.

The antireflection layer 30 is a layer having an antireflection function with respect to an incidence ray having a predetermined wavelength and is configured of a single layer or a multilayer of two or more layers. As the antireflection layer, a known layer having an antireflection function can be applied without particular limitation.

Here, an incidence ray having a predetermined wavelength is light having a wavelength at which reflection is planned to be prevented, and visible light (380 nm to 780 nm) is the main target in the present invention. It is preferable that the antireflection function is reflectivity of lower than or equal to 1% with respect to light having a wavelength of 550 nm, and it is more preferable that the antireflection function is reflectivity of lower than or equal to 1% with respect to light having a wavelength of 550 nm, and the wavelength range in which the reflectivity is lower than or equal to 1% covers the range of greater than or equal to 100 nm.

As described above, the antireflection layer 30 is formed by laminating, at least, the layer of high refractive index 32, the silver nano-disk layer 36, and the layer of low refractive index 38 in this order.

In a case where an aspect ratio of the silver nano-disk 35 is greater than or equal to 3, absorption of light in a visible light range is suppressed, and transmittance of light incident on the antireflection film can be made sufficiently high.

Main planes of the silver nano-disks 35 in the silver nano-disk layer 36 are subjected to plane alignment in a range of 0° to 30° with respect to the front surface of the silver nano-disk layer and are arranged in the binder 33 separately from each other, and thus, a conductive path is not formed in a plane direction. Furthermore, the silver nano-disks are arranged in a single layer without being superimposed on each other in a thickness direction.

By including the silver nano-disk layer in the antireflection layer 30, reflectivity of lower than or equal to 1% can be realized over a significantly wide wavelength range.

On the other hand, the present inventors found that, in a case where the hard coat layer 20 is not included in the configuration of the antireflection film of this embodiment, rubbing and impact in a humidity controlled environment (environment of 25° C. and 50%, and the like) that are normally tested do not pose a problem, however, in a case where the antireflection film is subjected to rubbing or impact in the environment in which the film is continuously in contact with water, which assumes rainfall and the like, problems such as peeling occurring at an interface between the silver nano-disk layer 36 and another layer and the film becoming cloudy due to exposure to the solar light for a long period of time arose. Such problems did not arise in a case of an antireflection layer having a configuration in which the silver nano-disk layer 36 was not included. It was found that the occurrence of peeling can be suppressed, and the film can be prevented from becoming cloudy by providing a hard coat layer between the antireflection layer 30 and the transparent substrate 10 as in this embodiment (refer to Examples described below). Mechanisms for the occurrence and suppression of the peeling and the cloudiness are not clearly understood, however, it is assumed that an effect of improving adhesiveness between the silver nano-disk layer and layers provided on both sides thereof is generated by the relaxation of stress generated in the silver nano-disk layer 36 by the hard coat layer.

That is, the hard coat layer in the present invention is a layer having a function of suppressing the peeling or the cloudiness that can occur in a case where the silver nano-disk layer is included.

Hereinafter, other constituents of the antireflection film will be described in detail.

<Transparent Substrate>

The transparent substrate 10 is not particularly limited insofar as the transparent substrate is optically transparent with respect to an incidence ray having a predetermined wavelength λ and can be suitably selected according to the purpose. The transparent substrate 10 is a transparent substrate having visible light transmittance of greater than or equal to 70%, and a transparent substrate having visible light transmittance of greater than or equal to 80% is more preferable.

The transparent substrate 10 may be a film shape, may have a single layer structure, or may have a laminated structure, and the size thereof may be determined according to the application.

Examples of the transparent substrate 10 include a film or a laminated film thereof which is formed of a polyolefin-based resin such as polyethylene, polypropylene, poly-4-methyl pentene-1, and polybutene-1; a polyester-based resin such as polyethylene terephthalate and polyethylene naphthalate; a polycarbonate-based resin, a polyvinyl chloride-based resin, a polyphenylene sulfide-based resin, a polyether sulfone-based resin, a polyphenylene ether-based resin, a styrene-based resin, an acrylic resin, a polyamide-based resin, a polyimide-based resin, and a cellulose-based resin such as cellulose acetate, and the like. Among them, a triacetyl cellulose (TAC) film and a polyethylene terephthalate (PET) film are particularly suitable.

The thickness of the transparent substrate 10 is generally approximately 10 μm to 500 μm. The thickness of the transparent substrate 10 is more preferably 10 μm to 100 μm, is even more preferably 20 to 75 μm, and is particularly preferably 35 to 75 μm. In a case where the thickness of the transparent substrate 10 is sufficiently thick, adhesion failure tends to rarely occur. In addition, in a case where the thickness of the transparent substrate 10 is sufficiently thin, the transparent substrate 10 is not excessively strong as a material, and thus, tends to be easily used for construction in a case of adhering onto a window glass of a building material or an automobile as an antireflection film. Further, by setting the transparent substrate 10 to be sufficiently thin, visible light transmittance tends to increase, and costs of raw materials tend to be reduced.

In a case where a PET film is used as the transparent substrate 10, a biaxially stretched product is preferably used, from the viewpoint of stiffness. It is preferable that the PET film includes an easily adhesive layer on a surface on which the antireflection structure is formed. This is because it is possible to suppress Fresnel reflection occurring between the PET film and a layer to be laminated and to further increase an antireflection effect by using the PET film including the easily adhesive layer. It is preferable that the film thickness of the easily adhesive layer is set such that an optical path length becomes ¼ with respect to a wavelength at which reflection is planned to be prevented. Furthermore, it is preferable that a refractive index of the easily adhesive layer is lower than a refractive index of the PET film (1.66, in a case of a biaxially stretched product) and higher than the refractive index of the hard coat layer, and it is particularly preferable that the refractive index of the easily adhesive layer is close to an intermediate value between the refractive index of the PET film and the refractive index of the hard coat layer (a refractive index of 1.56 to 1.6). Examples of the PET film including such an easily adhesive layer include LUMIRROR manufactured by TORAY INDUSTRIES, INC., COSMOSHINE manufactured by TOYOBO CO., LTD., and the like.

<Silver Nano-Disk Layer>

The silver nano-disk layer 36 is a layer formed by containing the plurality of silver nano-disks 35 in the binder 33. FIG. 2 is an SEM image of the silver nano-disk layer in plan view. As illustrated in FIG. 2, the silver nano-disks 35 are dispersed and arranged separately from each other.

—Silver Nano-Disk—

As described above, the plurality of silver nano-disks 35 contained in the silver nano-disk layer 36 are flat plate-like particles having two facing main planes. It is preferable that the silver nano-disks 35 are segregated on one surface of the silver nano-disk layer 36.

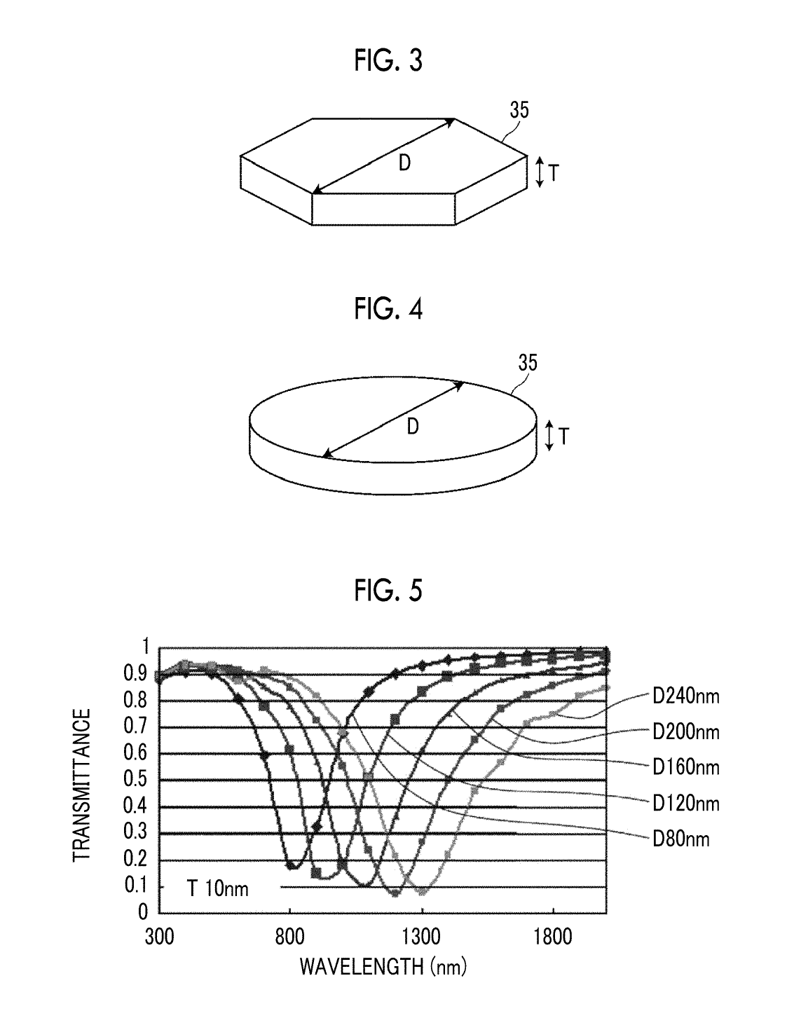

Examples of the shape of the main plane of the silver nano-disk 35 include a hexagonal shape, a triangular shape, a circular shape, and the like. Among them, from the viewpoint of high visible light transmittance, it is preferable that the shape of the main plane is a hexagonal or more multangular shape to a circular shape, and it is particularly preferable that the shape of the main plane is a hexagonal shape as illustrated in FIG. 3 or a circular shape as illustrated in FIG. 4.

Two or more types of silver nano-disks having a plurality of shapes may be used by being mixed.

Herein, the circular shape indicates a shape in which the number of sides having a length of greater than or equal to 50% of the average equivalent circle diameter described below is 0 per one silver nano-disk. The silver nano-disk having a circular shape is not particularly limited insofar as the silver nano-disk has a round shape without any angle in a case of observing the silver nano-disk from an upper portion of the main plane by using a transmission type electron microscope (TEM).

Herein, the hexagonal shape indicates a shape in which the number of sides having a length of greater than or equal to 20% of the average equivalent circle diameter described below is 6 per one silver nano-disk. Furthermore, the same applies to other multangular shapes. The silver nano-disk having a hexagonal shape is not particularly limited insofar as the silver nano-disk has a hexagonal shape in a case of observing the silver nano-disk from an upper portion of the main plane by using a transmission type electron microscope (TEM), and is able to be suitably selected according to the purpose, and for example, the angle of the hexagonal shape may be an acute angle or may be a blunt angle, but it is preferable that the angle becomes a blunt angle from the viewpoint of reducing absorption in a visible light range. The degree of the blunt angle is not particularly limited, and is able to be suitably selected according to the purpose.

[Average Particle Diameter (Average Equivalent Circle Diameter) and Coefficient of Variation]

The equivalent circle diameter indicates a diameter of a circle having an area identical to a projection area of each particle. The projection area of each particle is able to be obtained by a known method in which an area on an electron micrograph is measured and is corrected at an imaging magnification. In addition, in the average particle diameter (the average equivalent circle diameter), a particle diameter distribution (a particle size distribution) is obtained by the statistics of an equivalent circle diameter D of 200 silver nano-disks, and the arithmetic average is able to be calculated. A coefficient of variation of the particle size distribution of the silver nano-disks is able to be obtained by a value (%) which is obtained by dividing the standard deviation of the particle size distribution by the average particle diameter (the average equivalent circle diameter) described above.

In the antireflection film of the present invention, the coefficient of variation of the particle size distribution of the silver nano-disks is preferably less than or equal to 35%, is more preferably less than or equal to 30%, and is particularly preferably less than or equal to 20%. It is preferable that the coefficient of variation is less than or equal to 35% from the viewpoint of reducing absorption of a visible light ray in the antireflection structure.

The size of the silver nano-disk is not particularly limited, and is able to be suitably selected according to the purpose, and the average particle diameter is preferably 10 to 500 nm, is more preferably 20 to 300 nm, and is even more preferably 50 to 200 nm.

[Thickness and Aspect Ratio of Silver Nano-Disk]

In the antireflection film of the present invention, a thickness T of the silver nano-disk is preferably less than or equal to 20 nm, is more preferably 2 to 15 nm, and is particularly preferably 4 to 12 nm.

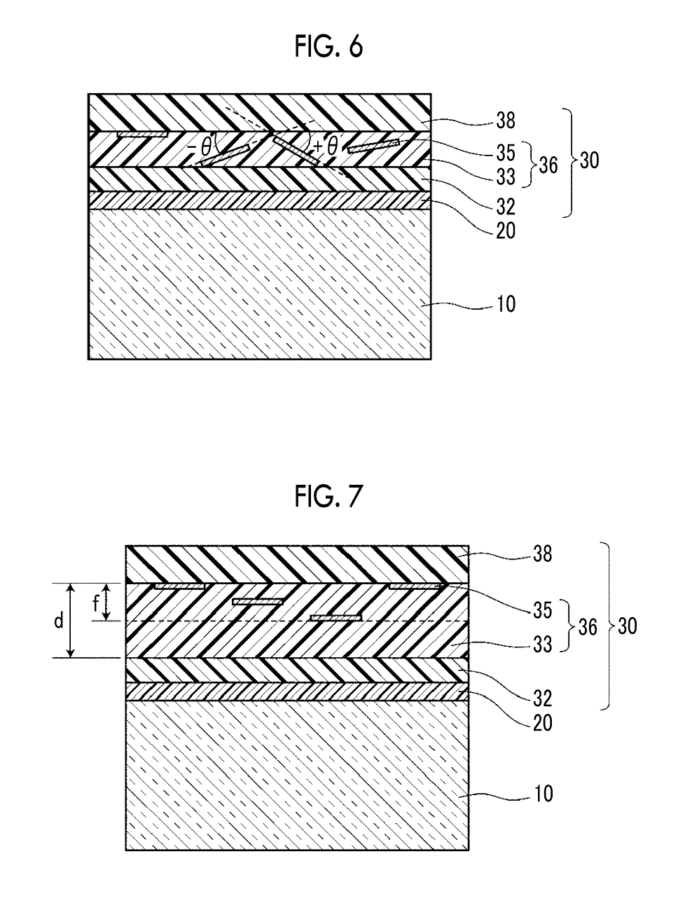

The particle thickness T corresponds to a distance between the main planes of the silver nano-disk, and for example, is illustrated in FIG. 5 and FIG. 6. The particle thickness T is able to be measured by an atomic force microscope (AFM) or a transmission type electron microscope (TEM).

Examples of a measurement method of the average particle thickness using AFM include a method in which a particle dispersion liquid containing a silver nano-disk is added dropwise onto a glass substrate and is dried, and a thickness per one particle is measured, and the like.

Examples of a measurement method of the average particle thickness using TEM include a method in which a particle dispersion liquid containing a silver nano-disk is added dropwise onto a silicon substrate and is dried, and then, a coating treatment is performed by carbon vapor deposition and metal vapor deposition, a cross-sectional segment is prepared by focused ion beam (FIB) processing, and the cross-sectional surface is observed by TEM, and thus, the thickness of the particle is measured, and the like.

In the present invention, a ratio D/T (the aspect ratio) of the diameter D of the silver nano-disks 35 (the average equivalent circle diameter) to the average thickness T is not particularly limited insofar as the ratio D/T is greater than or equal to 3, and can be suitably selected according to the purpose, and the ratio D/T is preferably 3 to 40, and is more preferably 5 to 40, from the viewpoint of reducing absorption of a visible light ray and a haze. In a case where the aspect ratio is greater than or equal to 3, it is possible to suppress the absorption of the visible light ray, and in a case where the aspect ratio is less than 40, it is also possible to suppress a haze in a visible range.

A simulation result of wavelength dependency of transmittance in a case where an aspect ratio of circular silver particles is changed is illustrated in FIG. 5. In the circular metal particles, a case is considered in which the thickness T is set to 10 nm, and the diameter D is changed to 80 nm, 120 nm, 160 nm, 200 nm, and 240 nm. As illustrated in FIG. 5, an absorption peak (the bottom of the transmittance) is shifted to a long wavelength side as the aspect ratio increases, and the absorption peak is shifted to a short wavelength side as the aspect ratio decreases. In a case where the aspect ratio is less than 3, the absorption peak is close to a visible range, and thus, in a case where the aspect ratio is 1, the absorption peak is in the visible range. Thus, in a case where the aspect ratio is greater than or equal to 3, it is possible to improve transmittance with respect to visible light. It is particularly preferable that the aspect ratio is greater than or equal to 5.

[Plane Alignment]

In the silver nano-disk layer 36, main planes of the silver nano-disks are subjected to plane alignment in a range of 0° to 30° with respect to the surface of the silver nano-disk layer 36. That is, in FIG. 6, an angle (A) between the surface of the silver nano-disk layer 36 and the main plane of the silver nano-disks 35 (a surface determining the equivalent circle diameter D) or an extended line of the main plane is 0° to 30°. It is more preferable that the plane alignment is performed in a range where the angle (±0) is 0° to 20°, and it is particularly preferable that the plane alignment is performed in a range where the angle (±0) is 0° to 10°. In a case where the cross-sectional surface of the antireflection film is observed, it is more preferable that the silver nano-disks 35 are aligned in a state where an inclination angle (±0) illustrated in FIG. 6 is small. In a case where θ is greater than ±30°, there is a concern in that the absorption of the visible light ray in the antireflection film increases.

In addition, the number of silver nano-disks subjected to the plane alignment in a range where the angle θ described above is 0° to ±30° is preferably greater than or equal to 50%, is more preferably greater than or equal to 70%, and is even more preferably greater than or equal to 90%, with respect to the total number of silver nano-disks.

In evaluation of whether or not the main plane of the silver nano-disks is subjected to the plane alignment with respect to one surface of the silver nano-disk layer, for example, it is possible to adopt a method in which a suitable cross-sectional segment is prepared, a silver nano-disk layer and a silver nano-disk in the segment are observed and evaluated. Specifically, examples of an evaluation method include a method in which a cross-sectional surface sample or a cross-sectional segment sample of the antireflection film is prepared by using a microtome and a focused ion beam (FIB), and evaluation is performed from an image obtained by observing the sample by using various microscopes (for example, a field-emission-type scanning electron microscope (FE-SEM), a transmission type electron microscope (TEM), and the like), and the like.

An observation method of the cross-sectional surface sample or the cross-sectional segment sample prepared as described above is not particularly limited insofar as whether or not the main plane of the silver nano-disk is subjected to the plane alignment with respect to one surface of the silver nano-disk layer in the sample can be confirmed, and examples of the observation method include a method using FE-SEM, TEM, and the like. In a case of the cross-sectional surface sample, the observation may be performed by FE-SEM, and in a case of the cross-sectional segment sample, the observation may be performed by TEM. In a case where the evaluation is performed by FE-SEM, it is preferable that the shape of the silver nano-disk and an inclination angle (±θ of FIG. 6) have obviously determinable spatial resolving power.

[Thickness of Silver Nano-Disk Layer and Presence Range of Silver Nano-Disk]

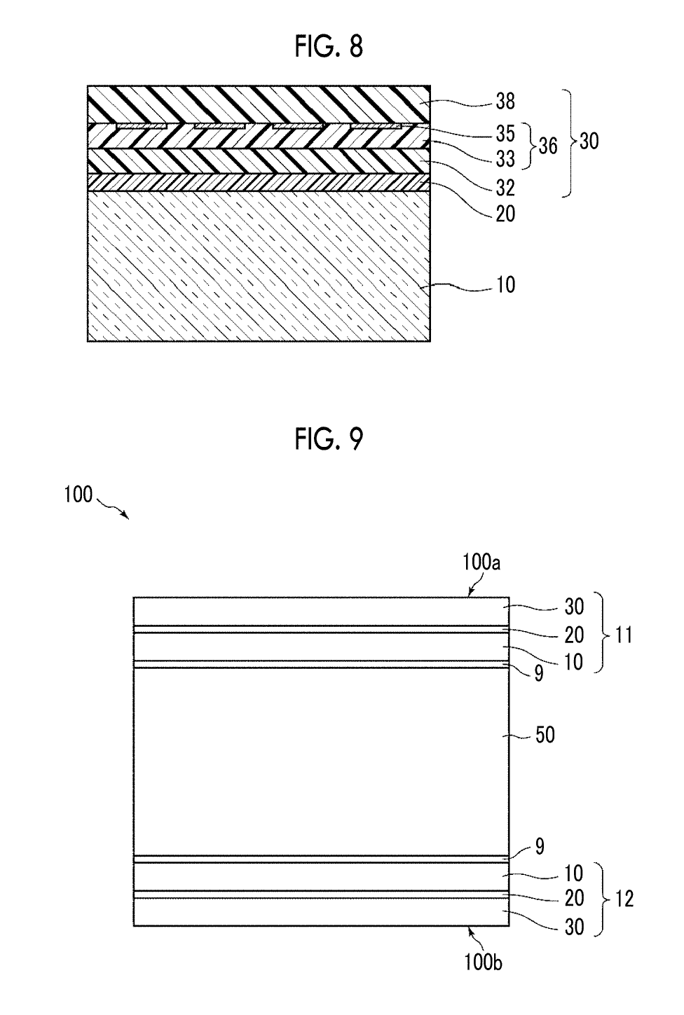

FIG. 7 and FIG. 8 are schematic cross-sectional views illustrating a presence state of the silver nano-disks 35 in the silver nano-disk layer 36.

An angle range of the plane alignment of the silver nano-disks is close to 0° as a coating thickness is decreased, and thus, the absorption of the visible light ray can be reduced. Therefore, a coated film thickness of the silver nano-disk layer 36 is preferably less than or equal to 100 nm, is more preferably 3 to 50 nm, and is particularly preferably 5 to 40 nm.

In a case where the coated film thickness d of the silver nano-disk layer 36 with respect to the average equivalent circle diameter D of the silver nano-disks is d>D/2, it is preferable that greater than or equal to 80 number % of the silver nano-disks 35 is present in a range of d/2 from the surface of the silver nano-disk layer 36, it is more preferable that greater than or equal to 80 number % of the silver nano-disks 35 is present in a range of d/3 from the surface of the silver nano-disk layer 36, and it is even more preferable that greater than or equal to 60 number % of the silver nano-disks is exposed to one surface of the silver nano-disk layer. The silver nano-disk being present in a range of d/2 from the surface of the silver nano-disk layer indicates that at least a part of the silver nano-disks is included in a range of d/2 from the surface of the silver nano-disk layer. FIG. 7 is a schematic view illustrating a case where the thickness d of the silver nano-disk layer is d>D/2, and in particular, illustrating that greater than or equal to 80 number % of the silver nano-disks is included in a range of f, and f<d/2.

In addition, the silver nano-disk being exposed to one surface of the silver nano-disk layer indicates that a part of one surface of the silver nano-disk is in an interface position with respect to the layer of low refractive index. FIG. 8 is a diagram illustrating a case where one surface of the silver nano-disk coincides with the interface with respect to the layer of low refractive index.

Here, a silver nano-disk presence distribution in the silver nano-disk layer, for example, is able to be measured by an image obtained by performing SEM observation with respect to the cross-sectional surface of the antireflection film.

Furthermore, the coated film thickness d of the silver nano-disk layer with respect to the average equivalent circle diameter D of silver nano-disks is preferably a case where d<D/2, is more preferably d<D/4, and is even more preferably d<D/8. As the coated film thickness of the silver nano-disk layer decreases, the angle range of the plane alignment of the silver nano-disks is close to 0°, and thus, the absorption of the visible light ray is able to be reduced, which is preferable.

A plasmon resonance wavelength (an absorption peak wavelength in FIG. 5) of the silver nano-disk in the silver nano-disk layer is not limited insofar as the wavelength is longer than a wavelength at which reflection is planned to be prevented, and can be suitably selected according to the purpose, however, in order to shield a heat ray, it is preferable that the plasmon resonance wavelength is 700 nm to 2,500 nm.

[Area Ratio of Silver Nano-Disk]

An area ratio [(B/A)×100] which is a ratio of a total value B of the area of the silver nano-disks to a total projection area A in the silver nano-disk layer at the time of being seen from a vertical direction with respect to the silver nano-disk layer is preferably from 5% to 40% and is more preferably from 10% to 40%. The conditions in which the aspect ratio of the silver nano-disk described above is greater than or equal to 3 are satisfied, and the area ratio is set to be from 5% to 40%, and thus, the reflectivity from the front surface and the reflectivity from the back surface in the antireflection structure are changed, and different reflectivity on the front surface and the back surface can be obtained.

Here, the area ratio, for example, can be measured by performing an image treatment with respect to an image which is obtained by performing SEM observation from an upper portion of the antireflection film or an image which is obtained by atomic force microscope (AFM) observation.

[Arrangement of Silver Nano-Disks]

It is preferable that the arrangement of the silver nano-disks in the silver nano-disk layer is even. Here, the evenness of the arrangement indicates that in a case where a distance to the closest particles with respect to each particle (a distance between the closest particles) is digitized by a distance between the centers of the particles, a coefficient of variation of the distance between the closest particles of each particle (=Standard Deviation/Average Value) is small. It is preferable that the coefficient of variation of the distance between the closest particles decreases, and the coefficient of variation is preferably less than or equal to 30%, is more preferably less than or equal to 20%, and is even more preferably less than or equal to 10%, and is ideally 0%. A case where the coefficient of variation of the distance between the closest particles is large is not preferable, since the silver nano-disks become crude or aggregation between the particles occurs in the silver nano-disk layer, and thus, the haze tends to deteriorate. The distance between the closest particles is able to be measured by observing the coated surface of the silver nano-disk layer with SEM or the like.

In addition, a boundary between the silver nano-disk layer and the layer of low refractive index is able to be determined by being similarly observed with SEM or the like, and the thickness d of the silver nano-disk layer is able to be determined. Furthermore, even in a case where the layer of low refractive index is formed on the silver nano-disk layer by using the same type of binder as the binder included in the silver nano-disk layer, in general, the boundary with respect to the silver nano-disk layer is able to be determined according to an image which has been subjected to SEM observation, and the thickness d of the silver nano-disk layer is able to be determined. Furthermore, in a case where the boundary is not obvious, the surface of flat plate metal in a position which is most separated from the substrate is assumed as the boundary.

[Synthesis Method of Silver Nano-Disk]

A synthesis method of the silver nano-disk is not particularly limited, and is able to be suitably selected according to the purpose, and examples of a method of synthesizing silver nano-disks having a hexagonal shape to a circular shape include a liquid phase method such as a chemical reduction method, a photochemical reduction method, and an electrochemical reduction method, and the like. Among them, a liquid phase method such as the chemical reduction method and the photochemical reduction method is particularly preferable from the viewpoint of controlling the shape and the size. Silver nano-disks having a hexagonal shape to a triangular shape may be synthesized, and then, for example, an etching treatment of dissolution species such as a nitric acid and sodium sulfite which dissolve silver, an aging treatment due to heating, and the like may be performed, and thus, the angle of the silver nano-disks having a hexagonal shape to a triangular shape may become a blunt angle, and silver nano-disks having a hexagonal shape to a circular shape may be obtained.

In addition, in the synthesis method of the silver nano-disk, seed crystals may be fixed onto the surface of a transparent substrate such as a film and glass in advance, and then, silver may be subjected to crystalline growth on a flat plate.

In the antireflection film of the present invention, in order to impart desirable properties, the silver nano-disk may be subjected to an additional treatment. Examples of the additional treatment include forming a shell layer of high refractive index and adding various additives such as a dispersant and an antioxidant.

—Binder—

The binder 33 in the silver nano-disk layer 36 preferably contains a polymer, and more preferably contains a transparent polymer. Examples of the polymer include a polymer such as a polyvinyl acetal resin, a polyvinyl alcohol resin, a polyvinyl butyral resin, a polyacrylate resin, a polymethyl methacrylate resin, a polycarbonate resin, a polyvinyl chloride resin, a (saturated) polyester resin, a polyurethane resin, and a natural polymer such as gelatin or cellulose. Among them, a polymer is preferable in which a main polymer is a polyvinyl alcohol resin, a polyvinyl butyral resin, a polyvinyl chloride resin, a (saturated) polyester resin, and a polyurethane resin, and a polymer is more preferable in which the main polymer is a polyester resin and a polyurethane resin, from the viewpoint of allowing greater than or equal to 80 number % of the silver nano-disks to be easily present in a range of d/2 from the surface of the silver nano-disk layer.

Two or more types of binders may be used in combination.

Among the polyester resins, the saturated polyester resin does not have a double bond, and thus, is particularly preferable from the viewpoint of imparting excellent weather fastness. In addition, a polyester resin having a hydroxyl group or a carboxyl group in a molecular terminal is more preferable from the viewpoint of obtaining high hardness, high durability, and high heat resistance by being cured with a water-soluble and water-dispersible curing agent or the like.

A commercially available polymer can be preferably used as the polymer, and examples of the commercially available polymer include PLASCOAT Z-687 manufactured by GOO CHEMICAL CO., LTD., which is a water-soluble polyester resin, HYDRAN HW-350 manufactured by DIC Corporation, which is a polyester polyurethane copolymer product, and the like.

In addition, herein, the main polymer contained in the silver nano-disk layer indicates a polymer component occupying greater than or equal to 50 mass % of the polymer contained in the silver nano-disk layer.

A content of a polyester resin and a polyurethane resin with respect to the silver nano-disks contained in the silver nano-disk layer is preferably 1 to 10,000 mass %, is more preferably 10 to 1,000 mass %, and is particularly preferably 20 to 500 mass %.

It is preferable that a refractive index n of the binder is 1.4 to 1.7.

<Layer of Low Refractive Index>

The refractive index of the layer of low refractive index 38 is smaller than the refractive index of the layer of high refractive index 32. In addition, the refractive index of the layer of low refractive index 38 is preferably lower than a refractive index of the transparent substrate 10. The refractive index of the layer of low refractive index is preferably lower than or equal to 1.40. For example, the refractive index of the layer of low refractive index may be approximately 1.35. An optical film thickness of the layer of low refractive index is preferably 30 nm to 100 nm. For example, the optical film thickness of the layer of low refractive index is approximately 70 nm.

The layer of low refractive index 38 contains, for example, a binder, refractive index controlling particles, and a surfactant and further contains additional components as necessary.

The binder in the layer of low refractive index is not particularly limited and can be suitably selected according to the purpose, and examples of the binder include a thermosetting or photocurable resin such as an acrylic resin, a silicone-based resin, a melamine-based resin, a urethane-based resin, an alkyd-based resin, and a fluorine-based resin, and the like.

The refractive index controlling particles are added in order to adjust the refractive index and can be suitably selected according to the purpose, and examples of the refractive index suppressing particles include hollow silica, and the like.

<Layer of High Refractive Index>

The refractive index of the layer of high refractive index 32 may be higher than the refractive index of the hard coat layer, and the refractive index of the layer of high refractive index 32 is higher than 1.5 and is particularly preferably from 1.6 to 1.8. A film thickness of the layer of high refractive index may be, for example, approximately 20 to 30 nm.

For example, the layer of high refractive index 32 contains a binder, metal oxide fine particles, a matting agent, and a surfactant, and contains other components as necessary. The binder is not particularly limited, and can be suitably selected according to the purpose, and examples of the binder include a thermosetting resin or a photocurable resin such as an acrylic resin, a silicone-based resin, a melamine-based resin, a urethane-based resin, an alkyd-based resin, and a fluorine-based resin, and the like. Among these, a urethane-based resin is preferable, and, from the viewpoint of forming a bond with the upper layer, a material having a reactive group such as a silanol group in the side chain is more preferable.

The material of the metal oxide fine particles is not particularly limited insofar as metal fine particles having a refractive index higher than the refractive index of the binder are used, and can be suitably selected according to the purpose, and examples of material of the metal oxide fine particles include tin-doped indium oxide (hereinafter, simply referred to as “ITO”), zinc oxide, titanium oxide, zirconium oxide, and the like. From the viewpoint of suppression of haze and smoothness of the surface, a primary particle diameter of the material is preferably less than or equal to 20 nm, is more preferably less than or equal to 15 nm, and is even more preferably less than or equal to 10 nm. Examples of the material include SZR-CW (particle diameter of 8 nm) manufactured by SAKAI CHEMICAL INDUSTRY CO., LTD.

<Additional Layers and Components>

The antireflection film of the present invention may include additional layers besides each of the above-described layers.

[Infrared Ray Absorbing Compound-Containing Layer]

The antireflection film of the present invention may include an infrared ray absorbing compound-containing layer containing a compound having absorbance in the infrared range, in order to shield a heat ray. Hereinafter, a layer containing the compound having absorbance in the infrared range is referred to as an infrared ray absorbing compound-containing layer. The infrared ray absorbing compound-containing layer may take a role of other functional layers.

[Pressure Sensitive Adhesive Layer]

The antireflection film of the present invention may include a pressure sensitive adhesive layer (hereinafter, referred to as a pressure sensitive adhesion layer). A material which can be used for forming the pressure sensitive adhesion layer is not particularly limited, and the material can be suitably selected according to the purpose, and examples of the material include a polyvinyl butyral (PVB) resin, an acrylic resin, a styrene/acrylic resin, a urethane resin, a polyester resin, a silicone resin, a natural rubber, a synthetic rubber, and the like. One these materials may be independently used, or two or more of these materials may be used in combination. The pressure sensitive adhesion layer formed of such materials can be formed by coating or lamination.

Further, an antistatic agent, a lubricant, an antiblocking agent, and the like may be added to the pressure sensitive adhesion layer.

It is preferable that the thickness of the pressure sensitive adhesion layer is 0.1 μm to 50 μm.

[Back Coating Layer]

The antireflection film may include a back coating layer on a surface of the transparent substrate on a side opposite to the surface on which the antireflection layer is formed. The back coating layer is not particularly limited and can be suitably selected according to the purpose, and the back coating layer may be a layer containing a compound having absorbance in the infrared range or may be a metal oxide particle-containing layer described below. In a case where a PET film is used as the transparent substrate, it is suitable to use an easily adhesive layer of the PET film as the back coating layer.

[Metal Oxide Particles]

The antireflection film of the present invention may contain at least one type of metal oxide particles in order to shield a heat ray.

A material of the metal oxide particles is not particularly limited and can be suitably selected according to the purpose, and examples of the material include tin-doped indium oxide (hereinafter, simply referred to as “ITO”), antimony-doped tin oxide (hereinafter, simply referred to as “ATO”), zinc oxide, zinc antimonate, titanium oxide, indium oxide, tin oxide, antimony oxide, glass ceramics, lanthanum hexaboride (LaB₆), cesium tungsten oxide (Cs_{0.33}WO₃, hereinafter, simply referred to as “CWO”), and the like. Among them, ITO, ATO, CWO, and lanthanum hexaboride (LaB₆) are more preferable from the viewpoint of excellent heat ray absorptive power and of manufacturing an antireflection structure having wider heat ray absorptive power by being combined with the flat plate particles, and ITO is particularly preferable from the viewpoint of shielding greater than or equal to 90% of an infrared ray of greater than or equal to 1,200 nm and of visible light transmittance of greater than or equal to 90%.

It is preferable that a volume average particle diameter of primary particles of the metal oxide particles is less than or equal to 0.1 μm in order not to decrease visible light transmittance.

The shape of the metal oxide particles is not particularly limited, is able to be suitably selected according to the purpose, and examples of the shape of the metal oxide particles include a spherical shape, a needle shape, a plate shape, and the like.

A method for producing the antireflection film 1 of this embodiment will be briefly described.

The transparent substrate 10 is prepared, and, first, the hard coat layer 20 is formed on the transparent substrate 10. The formation method of the hard coat layer is preferably a coating method. A coating liquid at least containing a water-soluble resin or a water-dispersible resin and water is prepared as a coating liquid for forming a hard coat layer, and the coating liquid is applied onto the transparent substrate and dried, and thus the hard coat layer 20 is formed.

Next, the layer of high refractive index 32 is formed on the hard coat layer 20. The formation method of the layer of high refractive index is preferably a coating method. A coating liquid for forming a layer of high refractive index is prepared, and the coating liquid for forming a layer of high refractive index is applied onto the hard coat layer 20 using a method of coating by a dip coater, a die coater, a slit coater, a bar coater, a gravure coater, or the like. Thereafter, the layer of high refractive index 32 is obtained by curing the coating liquid by light irradiation or heating, according to the resin constituting the binder of the layer of high refractive index.

Next, the silver nano-disk layer 36 is formed on the layer of high refractive index 32. The formation method of the silver nano-disk layer is not particularly limited, and examples thereof include a coating method, and a method of performing plane alignment using a method such as an LB film method, a self-organization method, and spray coating. A dispersion liquid containing silver flat plate particles (flat plate particle dispersion liquid) is applied using a dip coater, a die coater, a slit coater, a bar coater, a gravure coater, or the like, as a coating liquid for forming a silver nano-disk layer. Thereafter, the silver nano-disk layer is obtained by curing the coating liquid by light irradiation or heating, according to the resin constituting the binder of the silver nano-disk layer.

Furthermore, in order to accelerate the plane alignment, the silver nano-disk layer may pass through a pressure bonding roller such as a calendar roller or a laminating roller, after applying the coating liquid for forming a silver nano-disk layer.

Subsequently, the layer of low refractive index 38 is formed on the silver nano-disk layer 36. The formation method of the layer of low refractive index is preferably a coating method. A coating liquid for forming a layer of low refractive index is prepared, and the coating liquid for forming a layer of low refractive index is applied onto the silver nano-disk layer 36 using a method of coating by a dip coater, a die coater, a slit coater, a bar coater, a gravure coater, or the like. Thereafter, the layer of low refractive index 38 is obtained by curing the coating liquid by light irradiation or heating, according to the resin constituting the binder of the layer of low refractive index.

The antireflection film 1 can be produced by the above steps.

The present antireflection film includes the described silver nano-disk layer described above in the antireflection layer, and thus it is possible to impart asymmetry of reflectivity on the front surface and the back surface of the film, and the present antireflection film can have radio wave transmittance.

Furthermore, the present antireflection film includes the hard coat layer, and thus, resistance to rubbing or impact in the environment in which the film is continuously in contact with water is excellent, and decrease in transparency (the film becoming cloudy) is suppressed even in a case of long term usage outdoors.

[Functional Glass]

The antireflection film of the present invention is used by adhering to at least one of the front surface or the back surface of the glass plate to which functionality is planned to be imparted. That is, a functional glass of the present invention is formed by adhering the antireflection film of the present invention to at least one surface side thereof.

A configuration example of the functional glass of the present invention is shown in FIG. 9.

A functional glass 100 of the present invention includes a glass plate 50, a first antireflection film 11 adhering to one surface of the glass plate 50, and a second antireflection film 12 adhering to the other surface of the glass plate 50. Both of the first and second antireflection films 11 and 12 are an embodiment of the antireflection film of the present invention. The first and second antireflection films 11 and 12 may have the same reflection condition or may have reflection conditions different from each other. In a case where materials and film thicknesses of a low reflectivity layer and a high reflectivity layer, a thickness of the silver nano-disk layer, and/or a content of the silver nano-disks are different, reflection conditions (reflectivity on the front surface and the back surface of the film, a wavelength range having desired reflectivity, and the like) are generally different from each other.

The glass plate 50 is a glass which is applied to a window of an architectural structure, a shop window, a car window, or the like.

Both of the first and second antireflection films 11 and 12 include a pressure sensitive adhesive layer 9 on the back surface of the transparent substrate 10, and the first and second antireflection films 11 and 12 adhere to one surface and the other surface of the glass plate 50 through the pressure sensitive adhesive layer 9.

The functional glass which includes the antireflection film of the present invention has high visible light transmittance from the side on which the antireflection film adheres and a clear visual field. In addition, the functional glass has high radio wave transmittance and does not interrupt a radio wave of a mobile phone.

In a case where the antireflection film adheres to the window glass, the pressure sensitive adhesive layer may be provided on the surface of the transparent substrate of the antireflection film on the side on which the antireflection layer is not formed by coating or lamination, an aqueous solution containing a surfactant (mainly a nonionic surfactant) may be sprayed onto the surface of the window glass and the pressure sensitive adhesive layer surface of the antireflection film in advance, and thus, the antireflection film may be disposed on the window glass through the pressure sensitive adhesive layer. The pressure sensitive adhesive force of the pressure sensitive adhesive layer is low until moisture is evaporated, and thus, the position of the antireflection structure on the glass surface can be adjusted. The adhesion position of the antireflection structure with respect to the window glass is determined, and then, moisture remaining between the window glass and the antireflection film is swept away from the center of the glass towards an end portion by using a squeegee or the like, and thus, the antireflection film can be fixed onto the surface of the window glass. Thus, the antireflection film can be disposed on the window glass.

Imparting functionality to the window glass is attained by a method such as heating or pressure lamination in which the antireflection film mechanically adheres onto the glass plate by using laminator equipment. A laminator is prepared in which the glass plate passes through a slit area interposed between an overheated metal roll or a rubber roll having heat resistance from an upper portion and a rubber roll having heat resistance which is at room temperature or is heated from a lower portion. The antireflection film is placed on the glass plate such that the pressure sensitive adhesive surface is in contact with the glass surface, and the upper portion roll of the laminator is set to press the antireflection film, and thus, the glass plate passes through the laminator. In a case where the adhesion is performed by selecting a suitable roll heating temperature according to the type of pressure sensitive adhesive, the pressure sensitive adhesive force becomes strong, and thus, the adhesion can be performed such that air bubbles are not mixed thereinto. In a case where the antireflection film can be supplied in the shape of a roll, a tape-like film is continuously supplied to a heating roll from the upper portion, and the heating roll is set to have a wrap angle of approximately 90 degrees, and thus, the pressure sensitive adhesive layer of the antireflection film is preheated and is easily subjected to the adhesion, and both of elimination of the air bubbles and an improvement in the pressure sensitive adhesive force are able to be high dimensionally attained.

### EXAMPLES

Hereinafter, examples and comparative examples of the present invention will be described.

First, preparation of various coating liquids used for preparing an antireflection film of Examples and Comparative Examples will be described.

[Coating Liquid for Forming Hard Coat Layer]

(Coating Liquid A-1 for Forming Hard Coat Layer)

A coating liquid A-1 for forming a hard coat layer was prepared by mixing materials shown in Table 1 below, a binder, a surfactant, an auxiliary for film formation, and water, at formulation ratios indicated in Table 1.

TABLE 1

| | Parts by |
|---|---|
| Material of coating liquid A-1 | mass |
| Binder: polyurethane aqueous dispersion: TAKELAC WS-4000 | 425 |
| (manufactured by Mitsui Chemicals, Inc., solid contents | |
| of 30 mass %) | |
| Surfactant: sodium = bis(3,3,4,4,5,5,6,6-nonafluoro) = | 13 |
| 2-sulfoniteoxysuccinate (manufactured by FUJIFILM | |
| Finechemicals Co., Ltd., solid contents of 2 mass %, methanol | |
| solution) | |
| Auxiliary for film formation: 2-butoxyethanol | 100 |
| Water | 462 |

(Coating Liquid A-2 for Forming Hard Coat Layer)

A coating liquid A-2 for forming a hard coat layer was prepared by mixing materials shown in Table 2, a binder, an ultraviolet absorbent, a surfactant, an auxiliary for film formation, and water, at formulation ratios indicated in Table 2.

TABLE 2

| | Parts by |
|---|---|
| Material of coating liquid A-2 | mass |
| Binder: polyurethane aqueous dispersion: TAKELAC WS-4000 | 443 |
| (manufactured by Mitsui Chemicals, Inc., solid contents | |
| of 30 mass %) | |
| Triazine-based ultraviolet absorbent: (Tinuvin 479 DW | 35.5 |
| manufactured by BASF SE, solid contents of 40 mass %) | |
| Surfactant: sodium = bis(3,3,4,4,5,5,6,6-nonafluoro) = | 13 |
| 2-sulfoniteoxysuccinate (manufactured by FUJIFILM | |
| Finechemicals Co., Ltd., solid contents of 2 mass %, methanol | |
| solution) | |
| Auxiliary for film formation: 2-butoxyethanol | 100 |
| Water | 408.5 |

[Layer of High Refractive Index]

(Coating Liquid B-1 for Layer of High Refractive Index)

A coating liquid B-1 for a layer of high refractive index was prepared by mixing materials shown in Table 3 at formulation ratios shown in Table 3.

TABLE 3

| | Parts by |
|---|---|
| Material of coating liquid B-1 | mass |
| Binder: polyurethane aqueous dispersion: TAKELAC WS-4000 | 8.8 |
| (manufactured by Mitsui Chemicals, Inc., solid contents | |
| of 30 mass %, Tg: 136° C.) | |
| Zirconia aqueous dispersion: SZR-CW (manufactured by | 27.4 |
| SAKAI CHEMICAL INDUSTRY CO., LTD., solid contents | |
| of 30 mass %) | |
| Surfactant: sodium = bis(3,3,4,4,5,5,6,6-nonafluoro) = | 5.3 |
| 2-sulfoniteoxysuccinate (manufactured by FUJIFILM | |
| Finechemicals Co., Ltd., solid contents of 2 mass %, methanol | |
| solution) | |
| Water | 958.5 |

(Coating Liquid B-2 for Layer of High Refractive Index)

A coating liquid B-2 for a layer of high refractive index was prepared by mixing materials shown in Table 4 at formulation ratios shown in Table 4.

TABLE 4

| | Parts by |
|---|---|
| Material of coating liquid B-2 | mass |
| Binder: polyurethane aqueous dispersion: TAKELAC WS-4000 | 8.8 |
| (manufactured by Mitsui Chemicals, Inc., solid contents | |
| of 30 mass %) | |
| Zirconia aqueous dispersion: SZR-CW (manufactured by | 13.7 |
| SAKAI CHEMICAL INDUSTRY CO., LTD., solid contents | |
| of 30 mass %) | |
| Surfactant: sodium = bis(3,3,4,4,5,5,6,6-nonafluoro) = | 5.3 |
| 2-sulfoniteoxysuccinate (manufactured by FUJIFILM | |
| Finechemicals Co., Ltd., solid contents of 2 mass %, methanol | |
| solution) | |
| Water | 972.2 |

[Silver Nano-Disk Layer]

—Preparation of Silver Nano-Disk Dispersion Liquid c1A—

13 L of ion exchange water was measured in a reaction container of NTKR-4 (manufactured by Nippon Metal Industry Co., Ltd.), and 1.0 L of an aqueous solution of trisodium citrate (an anhydride) of 10 g/L was added and retained at 35° C. while being stirred by using a chamber including an agitator in which four propellers of NTKR-4 and four paddles of NTKR-4 were attached to a shaft of SUS316L. 0.68 L of an aqueous solution of a polystyrene sulfonic acid of 8.0 g/L was added, and 0.041 L of an aqueous solution of sodium boron hydride which was prepared to be 23 g/L by using an aqueous solution of sodium hydroxide of 0.04 N was further added. 13 L of an aqueous solution of silver nitrate of 0.10 g/L was added at 5.0 L/min.

1.0 L of an aqueous solution of trisodium citrate (an anhydride) of 10 g/L and 11 L of ion exchange water were added, and 0.68 L of an aqueous solution of potassium hydroquinone sulfonate of 80 g/L was further added. Stirring was performed at 800 rpm, and 8.1 L of an aqueous solution of silver nitrate of 0.10 g/L was added at 0.95 L/min, and then, and the temperature was lowered to 30° C.

8.0 L of an aqueous solution of methyl hydroquinone of 44 g/L was added, and then, the total amount of a gelatin aqueous solution at 40° C. described below was added. Stirring was performed at 1,200 rpm, and the total amount of a mixed liquid of a white precipitate of silver sulfite described below was added.

In a step where a pH change in the prepared liquid stopped, 5.0 L of an aqueous solution of NaOH of 1 N was added at 0.33 L/min. After that, 0.18 L of an aqueous solution of sodium 1-(m-sulfophenyl)-5-mercaptotetrazole of 2.0 g/L (dissolved by adjusting pH to be 7.0±1.0 with NaOH and citric acid (an anhydride)) was added, and 0.078 L of an aqueous solution of 1,2-benzisothiazolin-3-one (dissolved by adjusting the aqueous solution to be alkaline with NaOH) of 70 g/L was further added. Thus, a silver nano-disk dispersion liquid c1A was prepared.

—Preparation of Gelatin Aqueous Solution—

16.7 L of ion exchange water was measured in a dissolving tank of SUS316L. 1.4 kg of alkali-treated osgoniale gelatin (GPC weight-average molecular weight of 200,000) which had been subjected to a deionization treatment was added while being stirred at a low speed in an agitator of SUS316L. Further, 0.91 kg of alkali-treated osgoniale gelatin (GPC weight-average molecular weight of 21,000) which has been subjected to a deionization treatment, a proteolytic enzyme treatment, and an oxidation treatment of peroxide hydrogen was added. After that, the temperature rose to 40° C., the gelatin was simultaneously swelled and dissolved, and thus, the gelatin was completely dissolved.

—Preparation of Mixed Liquid of White Precipitate of Silver Sulfite—

8.2 L of ion exchange water was measured in a dissolving tank of SUS316L, and 8.2 L of an aqueous solution of silver nitrate of 100 g/L was added. 2.7 L of an aqueous solution of sodium sulfite of 140 g/L was added for a short period of time while being stirred at a high speed in an agitator of SUS316L, and thus, a mixed liquid including a white precipitate of the silver sulfite was prepared. The mixed liquid was prepared immediately before being used.

—Preparation of Silver Nano-Disk Dispersion Liquid c1B—

800 g of the silver nano-disk dispersion liquid c1A described above was sampled into a centrifuge tube, and pH was adjusted to be 9.2±0.2 at 25° C. with NaOH of 1 N and/or a sulfuric acid of 1 N. The temperature was set to 35° C., and a centrifugal operation was performed at 9,000 rpm for 60 minutes by using a centrifugal separator (himacCR22GIII, an angle rotor R9A, manufactured by Hitachi Koki Co., Ltd.), and then, 784 g of a supernatant was removed. An aqueous solution of NaOH of 0.2 mM was added to the precipitated flat plate particles such that the total amount thereof was set to 400 g, and stirring was manually performed by using a stirring rod, and thus, a coarse dispersion liquid was obtained. By performing the same operation, coarse dispersion liquids were prepared in 24 centrifuge tubes such that the total amount was set to 9,600 g, and were added to a tank of SUS316L and mixed. Further, 10 cc of a solution of Pluronic31R1 (manufactured by BASF SE) of 10 g/L (diluted with a mixed liquid of Methanol:Ion Exchange Water=1:1 (a volume ratio)) was added. A batch type disperse treatment was performed with respect to the coarse dispersion liquid mixture in the tank at 9,000 rpm for 120 minutes by using a 20 type automixer (a stirring portion is a homomixer MARKII) manufactured by PRIMIX Corporation. A liquid temperature during the dispersion was retained at 50° C. After the dispersion, the temperature was lowered to 25° C., and then, single-pass filtration was performed by using a PROFILE II filter (manufactured by Pall Corporation, a product type of MCY1001Y030H13).

Thus, the dispersion liquid c1 was subjected to a desalinization treatment and re-dispersion treatment, and thus, a silver nano-disk dispersion liquid c1B was prepared.

—Evaluation of Silver Nano-Disk—

It was confirmed that silver nano-disks having a hexagonal shape to a circular shape and a triangular shape were generated in the silver nano-disk dispersion liquid c1A. Silver fine particles in the dispersion liquid c1A were all silver nano-disks. An image obtained by TEM observation of the silver nano-disk dispersion liquid c1A was imported into image treatment software Image J, and an image treatment was performed. Any 500 particles extracted from TEM images in a plurality of visual fields were subjected to image analysis, and an equivalent circle diameter in the same area was calculated. As a result of performing statistic processing based on the parent population, the average diameter was 120 nm.

The silver nano-disk dispersion liquid c1B was similarly measured, and thus, approximately the same result as that of the silver nano-disk dispersion liquid c1A, which also included the shape of a particle size distribution, was obtained.

The silver nano-disk dispersion liquid c1B was added dropwise onto a silicon substrate and was dried, and a thickness of each of the flat plate particles was measured by a FIB-TEM method. Ten flat plate particles in the silver nano-disk dispersion liquid c1B were measured, and the average thickness was 8 nm. That is, an aspect ratio represented by diameter/thickness was 15.0.

—Preparation of Silver Nano-Disk Dispersion Liquids c2A and c2B—Silver nano-disk dispersion liquids c2A and c2B were prepared by adjusting a concentration of each solution, heating temperature, and pH during the preparation, such that the average thickness becomes 6 nm, and the average diameter becomes 20 nm in the preparation of silver nano-disk dispersion liquids c1A and c2B.

(Preparation of Coating Liquids C-1a to f for Silver Nano-Disk Layer)

A coating liquid C-1a for a silver nano-disk layer was prepared by mixing at formulation ratios of materials shown in Table 5.

TABLE 5

| | Parts by |
|---|---|
| Material of coating liquid C-1a | mass |
| Aqueous solution of polyurethane: HYDRAN HW-350 | 2.4 |
| (manufactured by DIC Corporation, concentration of | |
| solid contents of 30 mass %) | |
| Surfactant A: F LIPAL 8780P (manufactured by | 8.5 |
| Lion Corporation, solid contents of 1 mass %) | |
| Surfactant B: NAROACTY CL-95 (manufactured by | 10.6 |
| Sanyo Chemical Industries, Ltd., solid contents of | |
| 1 mass %) | |
| Silver nano-disk dispersion liquid c1B | 333 |
| 1-(5-Methylureidophenyl)-5-mercaptotetrazole (manufactured | 5.4 |
| by Wako Pure Chemical Industries, Ltd., solid contents of | |
| 2 mass %) | |
| Ethanol | 100 |
| Water | 540.1 |

Among the formulation ratios, amounts of the silver nano-disk dispersion liquid c1B and water in the coating liquid C-1a were suitably adjusted according to the desired area ratio of the silver nano-disks in the silver nano-disk layer, and coating liquids C-1b to C-1f for a silver nano-disk layer were separately prepared.

Formulation ratios of the silver nano-disk dispersion liquid c1B and water in each of the coating liquids C-1a to C-1f are shown in Table 6 below. Units are in parts by mass.

TABLE 6

| | Silver nano-disk dispersion liquid c1B | Water |
|---|---|---|
| C-1a | 333 | 540.1 |
| C-1b | 475.7 | 397.4 |
| C-1c | 118.9 | 754.2 |
| C-1d | 535.2 | 337.9 |
| C-1e | 59.5 | 813.6 |
| C-1f | 0.0 | 873.1 |

(Preparation of Coating Liquid C-2 for Silver Nano-Disk Layer)

A coating liquid C-2 was obtained by the same method as that for the preparation of the coating liquids C-1a to f, except that a silver nano-disk dispersion liquid c2B was used instead of the silver nano-disk dispersion liquid c1B in the preparation of the coating liquids C-1a to f.

(Preparation of Coating Liquid C-3 for Silver Nano-Disk Layer)

A coating liquid C-3 was obtained by the same method as that for the preparation of the coating liquids C-1a to f, except that an aqueous solution of spherical silver nanoparticle (diameter of 20 nm and aspect ratio of 1) dispersion liquid was used instead of silver nano-disks.

[Layer of Low Refractive Index]

(Coating Liquid D-1 for Layer of Low Refractive Index)

A coating liquid D-1 for a layer of low refractive index was prepared by mixing at formulation ratios of materials shown in Table 7.

TABLE 7

| | Parts by |
|---|---|
| Material of coating liquid D-1 | mass |
| Solution containing 4 mass % of the following Compound M-1 | 25.94 |
| (solvent: methyl ethyl ketone) | |
| Monomer: KAYARAD PET-30 (manufactured by | 0.28 |
| Nippon Kayaku Co., Ltd.) | |
| Hollow silica dispersion liquid: THRULYA 4320 (manufactured | 12.29 |
| by JGC C&C) | |
| Photopolymerization initiator: IRGACURE 127 (manufactured | 0.04 |
| by BASF Japan Ltd.) | |
| Methyl ethyl ketone | 56.22 |
| Cyclohexanone | 5.22 |

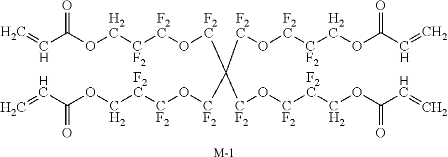 [SMILES: C=CC(=O)OCC(F)(F)C(F)(F)OC(F)(F)C(C(F)(F)OC(F)(F)C(F)(F)COC(=O)C=C)(C(F)(F)OC(F)(F)C(F)(F)COC(=O)C=C)C(F)(F)OC(F)(F)C(F)(F)COC(=O)C=C ; "M-1"]

Compound M-1 was prepared by the method described in paragraphs [0061] to [0097] in JP2006-284761A.

(Coating Liquid D-2 for Layer of Low Refractive Index)

A coating liquid D-2 for a layer of low refractive index was prepared by mixing at formulation ratios of materials shown in Table 8.

TABLE 8

| | Parts by |
|---|---|
| Material of coating liquid D-2 | mass |
| Solution containing 40 mass % of Compound M-1 (solvent: | 17.94 |
| methyl ethyl ketone) | |
| Monomer: KAYARAD PET-30 (manufactured by Nippon | 1.81 |
| Kayaku Co., Ltd.) | |
| Hollow silica dispersion liquid: OPSTAR TU2361 | 142.80 |
| (manufactured by JSR Corporation, solid contents | |
| of 10 mass %) | |
| Silica dispersion liquid: MEK-ST-L (manufactured by | 5.29 |
| Nissan Chemical Industries, Ltd., solid contents of | |
| 30 mass %) | |
| Photopolymerization initiator: IRGACURE 127 (manufactured | 0.24 |
| by BASF Japan Ltd.) | |
| Slipping agent: SILAPLANE FM-0725 (manufactured by | 0.76 |
| JNC Corporation) | |
| Methyl ethyl ketone | 831.16 |

(Coating Liquid D-3 for Layer of Low Refractive Index)

A coating liquid D-3 for a layer of low refractive index was prepared by mixing at formulation ratios of materials shown in Table 9.

TABLE 9

| | Parts by |
|---|---|
| Material of coating liquid D-3 | mass |
| Solution containing 40 mass % of Compound M-1 (solvent: | 17.94 |
| methyl ethyl ketone) | |
| Monomer: KAYARAD PET-30 (manufactured by Nippon | 1.81 |
| Kayaku Co., Ltd.) | |
| Hollow silica dispersion liquid: OPSTAR TU2361 | 142.80 |
| (manufactured by JSR Corporation, solid contents | |
| of 10 mass %) | |
| Silica dispersion liquid: MEK-ST-L (manufactured by | 5.29 |
| Nissan Chemical Industries, Ltd., solid contents of | |
| 30 mass %) | |
| Photopolymerization initiator: IRGACURE 127 (manufactured | 0.24 |
| by BASF Japan Ltd.) | |
| Slipping agent: SILAPLANE FM-0725 (manufactured by | 1.52 |
| JNC Corporation) | |
| Methyl ethyl ketone | 830.40 |

(Coating Liquid D-4 for Layer of Low Refractive Index)

A coating liquid D-4 for a layer of low refractive index was prepared by mixing at formulation ratios of materials shown in Table 10.

TABLE 10

| | Parts by |
|---|---|
| Material of coating liquid D-4 | mass |
| Solution containing 40 mass % of Compound M-1 (solvent: | 17.94 |
| methyl ethyl ketone) | |
| Monomer: KAYARAD PET-30 (manufactured by Nippon | 1.81 |
| Kayaku Co., Ltd.) | |
| Hollow silica dispersion liquid: OPSTAR TU2361 | 142.80 |
| (manufactured by JSR Corporation, solid contents | |
| of 10 mass %) | |
| Silica dispersion liquid: MEK-ST-L (manufactured by | 5.29 |
| Nissan Chemical Industries, Ltd., solid contents of | |
| 30 mass %) | |
| Photopolymerization initiator: IRGACURE 127 (manufactured | 0.24 |
| by BASF Japan Ltd.) | |
| Slipping agent: SILAPLANE FM-0725 (manufactured by | 0.25 |
| JNC Corporation) | |
| Slipping agent: TEGO Rad 2700 (manufactured by Evonik | 0.25 |
| Japan Co., Ltd.) | |
| Slipping agent: TEGO Rad 2500 (manufactured by Evonik | 0.07 |
| Japan Co., Ltd.) | |
| Methyl ethyl ketone | 831.34 |

Examples and Comparative Examples of the antireflection film of the present invention were respectively prepared using the coating liquids A-1, A-2, B-1, B-2, C-1a to C-1f, C-2, C-3, and D-1 to D-4 obtained by being prepared by the methods described above. The layer configuration of each of Examples and Comparative Examples are collectively shown in Table 11.

TABLE 11

| | |
|---|---|
| | Silver |
| Layer of high | nano-disk layer |

| | | |
|---|---|---|
| Hard coat layer | refractive index | Thickness |

| | Film | | | Film | | | Film | of silver |
|---|---|---|---|---|---|---|---|---|
| | thickness | Refractive | Coating | thickness | Refractive | Coating | thickness | nano-disk |
| | (μm) | index | liquid | (nm) | index | liquid | (nm) | (nm) |
| Example 1 | 4 | 1.5 | A-1 | 30 | 1.7 | B-1 | 30 | 8 |
| Example 2 | 4 | 1.5 | A-1 | 30 | 1.7 | B-1 | 30 | 8 |
| Example 3 | 4 | 1.5 | A-1 | 30 | 1.6 | B-2 | 30 | 8 |
| Example 4 | 1 | 1.5 | A-1 | 30 | 1.7 | B-1 | 30 | 8 |
| Example 5 | 10 | 1.5 | A-1 | 30 | 1.7 | B-1 | 30 | 8 |
| Example 6 | 4 | 1.5 | A-1 | 30 | 1.7 | B-1 | 30 | 6 |
| Example 7 | 4 | 1.5 | A-2 | 30 | 1.7 | B-1 | 30 | 8 |
| Example 8 | 4 | 1.5 | A-1 | 10 | 1.7 | B-1 | 30 | 8 |
| Example 9 | 4 | 1.5 | A-1 | 100 | 1.7 | B-1 | 30 | 8 |
| Example 10 | 4 | 1.5 | A-1 | 30 | 1.7 | B-1 | 30 | 8 |
| Example 11 | 4 | 1.5 | A-1 | 30 | 1.7 | B-1 | 30 | 8 |
| Example 12 | 4 | 1.5 | A-2 | 30 | 1.7 | B-1 | 30 | 8 |
| Example 13 | 4 | 1.5 | A-2 | 30 | 1.7 | B-1 | 30 | 8 |
| Example 14 | 4 | 1.5 | A-2 | 30 | 1.7 | B-1 | 30 | 8 |
| Comparative | N/A | | | 30 | 1.7 | B-1 | 30 | 8 |
| Example 1 | | | | | | | | |
| Comparative | N/A | | | | | | 30 | 8 |
| Example 2 | | | | | | | | |
| Comparative | N/A | | | | | | 30 | — |
| Example 3 | | | | | | | | |
| Comparative | 4 | 1.5 | A-1 | 30 | 1.7 | B-1 | 30 | 20 |
| Example 4 | | | | | | | | |
| Comparative | 4 | 1.5 | A-1 | 30 | 1.35 | — | 30 | 8 |
| Example 5 | | | | | | | | |

| | Silver nano-disk layer | | | | | |
|---|---|---|---|---|---|---|
| | Diameter of | Area ratio | | Layer of low refractive index | | |
| | silver | of silver | | Film | | |
| | nano-disk | nano-disk | Coating | thickness | Refractive | Coating |
| | (nm) | (%) | liquid | (nm) | index | liquid |
| Example 1 | 120 | 10 | C-1c | 75 | 1.35 | D-1 |
| Example 2 | 120 | 28 | C-1a | 75 | 1.35 | D-1 |
| Example 3 | 120 | 40 | C-1b | 75 | 1.35 | D-1 |
| Example 4 | 120 | 28 | C-1a | 75 | 1.35 | D-1 |
| Example 5 | 120 | 28 | C-1a | 75 | 1.35 | D-1 |
| Example 6 | 20 | 28 | C-2 | 75 | 1.35 | D-1 |
| Example 7 | 120 | 28 | C-1a | 75 | 1.35 | D-1 |
| Example 8 | 120 | 28 | C-1a | 75 | 1.35 | D-1 |
| Example 9 | 120 | 28 | C-1a | 75 | 1.35 | D-1 |
| Example 10 | 120 | 45 | C-1d | 75 | 1.35 | D-1 |
| Example 11 | 120 | 5 | C-1e | 75 | 1.35 | D-1 |
| Example 12 | 120 | 28 | C-1a | 75 | 1.35 | D-2 |
| Example 13 | 120 | 28 | C-1a | 75 | 1.35 | D-3 |
| Example 14 | 120 | 28 | C-1a | 75 | 1.35 | D-4 |
| Comparative | 120 | 28 | C-1a | 75 | 1.35 | D-1 |
| Example 1 | | | | | | |
| Comparative | 120 | 28 | C-1a | 75 | 1.35 | D-1 |
| Example 2 | | | | | | |
| Comparative | — | 0 | C-1f | 75 | 1.35 | D-1 |
| Example 3 | | | | | | |
| Comparative | 20 | 25 | C-3 | 75 | 1.35 | D-1 |
| Example 4 | | | | | | |
| Comparative | 120 | 28 | C-1a | 75 | 1.35 | D-1 |
| Example 5 | | | | | | |

A preparation method of an antireflection film of each of Examples and Comparative Examples will be described.

### Example 1

The coating liquid A-1 for a hard coat layer was applied onto one surface of a polyethylene terephthalate (PET) film (U403, film thickness 50 of μm, manufactured by Toray Industries, Inc.) with an easily adhesive layer, which served as a transparent substrate, by using a wire bar such that the average thickness after being dried became 4 μm, and the coating liquid was dried at 150° C. for 2 minutes, and thus a hard coat layer was formed.

After that, the coating liquid B-1 for a layer of high refractive index was applied by using a wire bar such that the average thickness after being dried became 30 nm, and the coating liquid was cured by being heated and dried at 150° C. for 1 minute, and thus a layer of high refractive index was formed.

Next, the coating liquid C-1c for a silver nano-disk layer was applied onto a surface of the layer of high refractive index by using a wire bar such that the average thickness after being dried became 30 nm. After that, the coating liquid was heated, dried, and solidified at 130° C. for 1 minute, and thus a silver nano-disk layer was formed. The coating liquid D-1 for a layer of low refractive index was applied onto the silver nano-disk layer thus formed by using a wire bar such that the average thickness after being dried became 75 nm, and the coating liquid was cured by being heated and dried at 130° C. for 1 minute, and thus a layer of low refractive index was formed.

An antireflection film of Example 1 in which the hard coat layer, the layer of high refractive index, the silver nano-disk layer, and the layer of low refractive index were laminated in this order on the transparent substrate formed of the PET film was obtained through the above steps.

### Examples 2 to 14 and Comparative Example 4

Antireflection films of Examples 2 to 14 and Comparative Example 4 were obtained by the same method as that in Example 1, except that the coating liquid and the film thickness of each layer in Example 1 were respectively changed to the coating liquid and the film thickness indicated in Table 11. That is, antireflection films in which a hard coat layer, a layer of high refractive index, a silver nano-disk layer, and a layer of low refractive index were laminated in this order on the transparent substrate formed of the PET film were obtained as Examples 2 to 14 and Comparative Example 4.

### Comparative Example 1

An antireflection film of Comparative Example 1 was obtained by the same method as that in Example 1, except that the hard coat layer was not formed, and the layer of high refractive index was directly applied onto the surface of the PET film in Example 1. That is, an antireflection film in which the layer of high refractive index, the silver nano-disk layer, and the layer of low refractive index were laminated on the transparent substrate formed of the PET film was obtained as Comparative Example 1.

### Comparative Example 2

An antireflection film of Comparative Example 2 was obtained by the same method as that in Example 1, except that the hard coat layer and the layer of high refractive index were not formed, and the silver nano-disk layer was directly applied onto the surface of the PET film in Example 1. That is, an antireflection film including the silver nano-disk layer and the layer of low refractive index on the transparent substrate formed of the PET film was obtained as Comparative Example 2.

### Comparative Example 3

An antireflection film of Comparative Example 3 was obtained by the same method as that in Example 1, except that the hard coat layer and the layer of high refractive index were not formed, and a coating liquid which only contains a binder in the coating liquid for a silver nano-disk layer and does not contain the silver nano-disk was directly applied onto the surface of the PET film in Example 1. That is, an antireflection film including a binder layer and the layer of low refractive index on the transparent substrate formed of the PET film was obtained as Comparative Example 3.

### Comparative Example 5

An antireflection film of Comparative Example 5 was obtained by the same method as that in Example 2, except that a magnesium fluoride layer having a refractive index of 1.35 was formed by the following method, instead of forming the layer of high refractive index in Example 2. Vapor deposition was performed on magnesium fluoride on the same PET film as that in Example 1 on which the hard coat layer was formed under the following condition, using a vacuum vapor deposition apparatus including an electron beam evaporation source. After setting the PET film on the vacuum vapor deposition apparatus, evacuation was performed at a pressure of lower than or equal to 5×10⁻³ Pa. An evaporation rate of magnesium fluoride was monitored using a quartz crystal film thickness monitor. The evaporation rate of magnesium fluoride was controlled by adjusting an electron beam current of the electron beam evaporation source, such that a film thickness of a magnesium fluoride vapor-deposited thin film layer obtained on a PET film outermost surface layer became 30 nm, and thus a desired magnesium fluoride layer was obtained.

<Evaluation>

Light-fast (haze), reflectivity at a wavelength of 550 nm, and film hardness in each of Examples and Comparative Examples were evaluated. Hereinafter, a measurement method and an evaluation method of each item will be described.

[Light-Fast Test]

Ultraviolet light was irradiated on the antireflection film of each of Examples and Comparative Examples from a side of the layer of low refractive index for 170 hours using an accelerated weathering tester (EYE SUPER UV TESTER SUV-W161, manufactured by IWASAKI ELECTRIC CO., LTD.) under the test condition of irradiation illuminance of 90 mW/cm², 63° C., and 50% RH, and haze was measured before and after the test.

—Haze—

Haze of the antireflection film of each of Examples and Comparative Examples was measured using a haze meter (NDH5000, manufactured by NIPPON DENSHOKU INDUSTRIES CO., LTD.). The measurement of haze was performed in a state in which the layer of low refractive index side of the antireflection film is disposed to be a light source side of the haze meter.

Haze values before the light-fast test are shown in Table 12. On the specimen after the light-fast test, measurement of haze and visual evaluation of yellowing and cloudiness were performed together, and the results of performing the evaluation under the following evaluation standard are shown in Table 12.

A: Yellowing and cloudiness does not occur

B: Yellowing occurs, and cloudiness does not occur

C: Yellowing occurs, and cloudiness occurs with haze of lower than or equal to 3%

D: Yellowing occurs, and cloudiness occurs with haze of higher than 3% and lower than 20%

E: Yellowing occurs, and cloudiness occurs with haze of higher than or equal to 20%

[Surface Reflectivity]

The surface of the antireflection film of each of Examples and Comparative Examples opposite to the layer of low refractive index (the back surface of the transparent substrate) was coated with a black ink (Artline KR-20 black manufactured by Shachihata Inc.), and reflection on the back surface in the visible light range was removed. Measurement of specular reflection at 5° in a case where light was incident from the layer of low refractive index side was performed using a UV-visible/NIR spectrophotometer (V560, manufactured by JASCO Corporation), reflectivity was measured at a wavelength of 450 nm to 650 nm, and an average value was calculated. The results are shown in Table 12. An average value of lower than 1.4% is designated as the target value of the average value of surface reflectivity.

[Scratch Resistance Evaluation]

Using a continuous loading scratch resistance strength tester (TYPE: 18, manufactured by Shinto Scientific Co., Ltd.), a load of 200 g/cm² was applied after mounting ASPURE WIPER (manufactured by AS ONE Corporation) and allowing pure water to permeate therethrough, and the surface of the antireflection film of each of Examples and Comparative Examples on the layer of low refractive index side was allowed to reciprocate 5,000 times. A wear state of a sample was observed visually and under an optical microscope. Evaluation of scratch resistance (film hardness) was performed under the following evaluation standard.

A: The sample is in a state in which the state after rubbing is not observed at all

B: The state after rubbing can be confirmed as a trace of rubbing

C: The state after rubbing can be confirmed as a width of greater than or equal to 1 mm

[Scratch Resistance Evaluation in Environment without Water]

Using continuous loading scratch resistance strength tester (TYPE: 18, manufactured by Shinto Scientific Co., Ltd.), a load of 200 g/cm² was applied in an environment without water after mounting ASPURE WIPER (manufactured by AS ONE Corporation) and adjusting humidity for one hour in an environment of 25° C. and 50%, and the surface of the antireflection film of each of Examples and Comparative Examples on the layer of low refractive index side was allowed to reciprocate 5,000 times. A wear state of a sample was observed visually and under an optical microscope. As a result, scratch was not observed in any of the samples of Examples and Comparative Examples.

From the results of evaluation of scratch resistance in the environment without water, it is clear that there is no problem in scratch resistance in an antireflection film including a silver nano-disk layer even in a case where the antireflection film does not include a hard coat layer, insofar as the film is in an environment without water.

[Evaluation of Sight Line-Focus Ratio]

Evaluation of a sight line-focus ratio of the antireflection film of each of Examples and Comparative Examples was performed.

The sight line-focus ratio is acquired in the following manner.

The antireflection film adheres to both surfaces of a window glass of a building (width of 1120 mm and high of 2100 mm). Samples of a certain commercial product were disposed on the front surfaces of the window glasses in the inside of the building and the outside of the building.

On a sunny day afternoon, an image in which both of a reflection image from the sample in the outside of the building and a transmission image of the sample in the inside of the building exist together was captured from a position 3 meters away from the front surface of the window glass outside of the building in a diagonal direction of 10 degrees using a digital camera, under the condition of outdoor illuminance of 90,000 lux and indoor illuminance of 2,000 lux.

The acquired image was displayed on an entire 24-inch liquid crystal monitor (G2410t) manufactured by Dell Inc. for 10 seconds, and the image was presented to the subjects. The spot in the image at which the subject observed in a case where the image was presented was acquired as time-series data of a coordinate using an eye tracker (Tobii X2-30) manufactured by Tobii Technology K.K.

The acquired time-series data of a coordinate was analyzed using a numerical software MATLAB manufactured by The MathWorks, Inc., and during the period of 10 seconds of the image display, time t during which a rectangular region in the image including the sample in the inside of the building was observed was calculated.

The same evaluation was performed with ten males and females in their 20s to 50s, and the average value of t/10 was calculated as the sight line-focus ratio.

Evaluation of the sight line-focus ratio was performed under the following evaluation standard. A and B indicate practically acceptable levels, and C indicates a level that cannot be put to practical use.

A: Sight line-focus ratio 50%

B: 50%> sight line-focus ratio 25%

C: 25%> sight line-focus ratio

For each of Examples and Comparative Examples, evaluation results for the evaluation items described above are shown in Table 12.

TABLE 12

| | Evaluation result | | | | |
|---|---|---|---|---|---|
| | | | | Evaluation | |
| | | Surface | | result after | Sight |
| | Haze | reflectivity | Scratch | light-fast | line-focus |
| | (%) | (%) | resistance | test | ratio |
| Example 1 | 0.7 | 0.3 | A | B | A |
| Example 2 | 0.5 | 0.1 | A | B | A |
| Example 3 | 0.6 | 0.3 | A | B | A |
| Example 4 | 0.7 | 0.5 | A | C | A |
| Example 5 | 0.7 | 0.7 | A | C | A |
| Example 6 | 0.6 | 0.9 | A | B | A |
| Example 7 | 0.6 | 0.1 | A | A | A |
| Example 8 | 0.6 | 0.5 | A | B | A |
| Example 9 | 0.6 | 0.5 | A | B | A |
| Example 10 | 0.9 | 1.1 | B | B | B |
| Example 11 | 0.5 | 1.1 | A | B | B |
| Example 12 | 0.5 | 0.1 | A | A | A |
| Example 13 | 0.6 | 0.1 | A | A | A |
| Example 14 | 0.6 | 0.1 | A | A | A |
| Comparative | 0.6 | 0.4 | C | E | A |
| Example 1 | | | | | |
| Comparative | 0.6 | 0.5 | C | E | A |
| Example 2 | | | | | |
| Comparative | 0.5 | 1.5 | A | B | C |
| Example 3 | | | | | |
| Comparative | 1.2 | 2 | A | B | C |
| Example 4 | | | | | |
| Comparative | 0.8 | 1.6 | C | E | C |
| Example 5 | | | | | |

It was found that sufficiently low surface reflectivity was obtained, scratch resistance was high, and light-fast was high in Examples 1 to 14. In a case where the area ratio of the silver nano-disks was greater than or equal to 10% and less than 40%, as in Examples 1 to 9 and 12 to 14, surface reflectivity was less than 1%, and preferable surface reflectivity characteristics were able to be obtained. Furthermore, it was found that yellowing of the film was suppressed by adding an ultraviolet absorbent in the hard coat layer in Examples 7 and 12 to 14, which was particularly preferable. In a configuration which does not include a hard coat layer, as in Comparative Examples 1 and 2, scratch resistance is low in an environment in which the film is continuously in contact with water, and the films cannot withstand practical use. In a case where silver nano-disks are not included or spherical particles are contained, as in Comparative Examples 3 and 4, reflectivity was greater than or equal to 1.5%, and an antireflection function was insufficient. This is clear from the result of the sight line-focus ratio which is an evaluation indicator in the actual use form of the antireflection function. In addition, it was found that degradation in scratch resistance was caused by the presence of the silver nano-disk layer, from the fact that there was no problem in scratch resistance in an environment in which the film was continuously in contact with water, in a case where the silver nano-disks were not contained, as in Comparative Example 3, and scratch resistance was slightly more degraded in Example 10, in which the amount of the silver nano-disks was large, than in other Examples. Furthermore, the refractive index of the hard coat layer was higher than that of the layer of high refractive index in Comparative Example 5, and it was understood that, in this case, surface reflectivity became great, and scratch resistance became low.

### EXPLANATION OF REFERENCES

1, 11, 12: antireflection film
10: transparent substrate
20: hard coat layer
30: antireflection layer
32: layer of high refractive index
35: silver nano-disk
36: silver nano-disk layer
38: layer of low refractive index
100: functional glass
T: (average) thickness of flat plate particles
D: (average) particle diameter or (average) equivalent circle diameter of flat plate particles

What is claimed is:

1. An antireflection film comprising:
a transparent substrate;
an antireflection layer provided on one surface side of the transparent substrate; and
a hard coat layer provided between the transparent substrate and the antireflection layer,
wherein the antireflection layer is formed by laminating, from the hard coat layer side, a layer of high refractive index having a refractive index higher than a refractive index of the hard coat layer, a silver nano-disk layer formed by dispersing a plurality of silver nano-disks in a binder, and a layer of low refractive index having a refractive index lower than the refractive index of the layer of high refractive index in this order.

2. The antireflection film according to claim 1,
wherein the hard coat layer is formed of a cured product of an aqueous resin composition.

3. The antireflection film according to claim 2,
wherein a resin in the aqueous resin composition is a polyurethane or an acrylic resin.

4. The antireflection film according to claim 1,
wherein a film thickness of the hard coat layer is from 1 μm to 10 μm.

5. The antireflection film according to claim 1,
wherein the transparent substrate is a polyester film.

6. The antireflection film according to claim 3,
wherein the transparent substrate is a polyester film, and a film thickness of the hard coat layer is from 1 μm to 10 μm.

7. The antireflection film according to claim 1,
wherein an area ratio of the silver nano-disks in the silver nano-disk layer in planar view is from 10% to 40%.

8. The antireflection film according to claim 6,
wherein an area ratio of the silver nano-disks in the silver nano-disk layer in planar view is from 10% to 40%.

9. The antireflection film according to claim 1,
wherein the layer of low refractive index is formed by dispersing hollow silica in the binder.

10. The antireflection film according to claim 8,
wherein the layer of low refractive index is formed by dispersing hollow silica in the binder.

11. A functional glass comprising:
a glass plate; and
the antireflection film according to claim 1 adhering to at least one surface of the glass plate.

12. A functional glass comprising:
a glass plate; and
the antireflection film according to claim 10 adhering to at least one surface of the glass plate.
